(19) United States
(12) Patent Application Publication
(10) Pub. No.: US 2015/0120326 A1
(43) Pub. Date: Apr. 30, 2015

(54) System and Methods for Controlling User Access to Content from One or More Content Source

(71) Applicant: Lexmark International Technology, S.A., Geneva (CH)

(72) Inventors: Razvan Atanasiu, Victoria, MN (US); Jeffrey Allen Romatoski, Woodbury, MN (US)

(21) Appl. No.: 14/530,498

(22) Filed: Oct. 31, 2014

Related U.S. Application Data
(60) Provisional application No. 61/898,004, filed on Oct. 31, 2013.

(51) Int. Cl. G06F 19/00

(52) U.S. Cl. CPC G06F 19/322
USPC 705/3

(57) ABSTRACT

A method for controlling user access to content generated from at least one of a first and a second content source includes creating a first and a second group, associating the first and the second groups with the first and the second content sources, respectively, assigning the one or more users to at least one of the groups and providing the users access to content generated by the content source associated with the one or more groups to which the users are assigned.

### CROSS REFERENCES TO RELATED APPLICATIONS

The present application is related to and claims priority under 35 U.S.C. 119(e) from U.S. Provisional Patent Application Ser. No. 61/898,004, filed Oct. 31, 2013, entitled, “System and Methods for Controlling User Access to Content from One or More Content Sources,” the contents of is which hereby incorporated by reference in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present invention relates generally to a system and methods of controlling user access of content from one or more content sources. More particularly, it relates to methods of controlling user access to content based on groups and assigning authority identifiers corresponding to the content sources.

2. Description of the Related Art

In a multi-enterprise environment such as the healthcare industry, a single user (e.g., a patient) may be assigned multiple user identifiers (IDs) (e.g., patient IDs). For example, a single patient may be assigned one patient ID in one facility and then be assigned another, different patient ID when checking in or receiving services in another facility. In current configurations, content for patients may be sent to a storage server, and the different patient IDs are stored in different databases, and current graphical user interface (GUI) tools may allow users to view content from multiple facilities. For example, users of Hospital A can view data of patients from Hospital B, which may cause any number of issues or concerns, such as privacy, organization, among others.

Accordingly, there is a need for a method of controlling user access to content in a multi-enterprise environment. There is a need for a method that would organize content associated with a user such that the user may be allowed to access only the content that is authorized for his or her viewing.

### SUMMARY

A method and a system for controlling user access to content based on the content source or the assigning authority and groups the user is assigned to are disclosed. The to method includes creating a first and a second group, associating the first and the second groups with the first and the second content sources, respectively, assigning the one or more users to at least one of the groups and providing the users access to content generated by the content source associated with the one or more groups to which the users are assigned.

The system for controlling user access to content includes one or more content sources or assigning authorities that generate content associated with the user, a server that receives the content from the content sources, associates the content with a content source identifier corresponding on the content source that generated the content. The server may also create a group for each of the content sources and assign a user of the system to at least one of the groups, the groups indicating that the user is allowed access to content generated by the content source associated with the group the user belongs to.

From the foregoing disclosure and the following detailed description of various example embodiments, it will be apparent to those skilled in the art that the present disclosure provides a significant advance in the art of methods for enabling network-based processes in a device during a network downtime condition. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows one example system that includes a server, content sources, and a client computer for use in controlling access of users to content from the content sources.

FIG. 2 shows one example method for controlling access of one or more users to content from one or more content sources based on assigning authority and active groups.

### DETAILED DESCRIPTION OF THE DRAWINGS

It is to be understood that the disclosure is not limited to the details of construction and the arrangement of components set forth in the following description or to illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and ^{an} herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in software. As such, it should be noted that a plurality of hardware and software-based devices may be utilized to implement the present invention.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data to processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

One of ordinary skill in the art, and based on a reading of this detailed description, would recognize that, in at least one example embodiment, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific mechanical configurations illustrated in the drawings are intended to illustrate example embodiments of the disclosure, and other alternative mechanical configurations are possible.

Disclosed are methods and a system for organizing content and controlling user access of content generated by one or more content sources in a multi-enterprise environment. One example method organizes content by tagging the content with an identifier corresponding to the content source or, in a Digital Imaging and Communications in Medicine (DICOM) environment, the assigning authority. It will be understood that the assigning authority refers to any system, agency or other authority that creates patient IDs and ensures that the patient IDs are unique for each patient within the domain. For example, the assigning authority may refer to the content source or the facility who assigned the ID to the patient or who generated the content associated with the patient. For illustrative purposes, to a healthcare-related system that utilize a vendor neutral archive server and DICOM images may be used to describe the example method, and the terms “user” and “patient” may be used interchangeably herein.

For purposes of the present disclosure, it will be appreciated that the content may refer to files such as, for example, documents, image files, audio files, among others. Content may refer to paper-based records converted into digital files to be used by a computing device. Content may also refer to information that provides value for an end-user or content consumer in one or more specific contexts. Content may be shared via one or more media such as, for example, computing devices in a network. In one example embodiment, content may refer to an electronic health record (EHR) which may be a digital content capable of being distributed, accessed or managed across various health care settings. EHRs may include various types of information such as, for example, medical history, demographics, immunization status, radiology images, medical allergies, personal states (e.g. age, weight), vital signs and billing information, among others.

Content may also refer include computerized medical records, or electronic medical records (EMRs), created in a health organization, or any organization that delivers patient care such as, for example, a physician's office, a hospital, or ambulatory services environments. EMRs may include orders for drug prescriptions, orders for tests, patient admission information, imaging test results, laboratory results, and clinical progress information, among others.

EHRs may include EMRs, and EHRs and EMRs together may also be referred to as an electronic patient record (EPR). The terms EHR, EPR, EMR, document, content and object may be used interchangeably for illustrative purposes throughout the present disclosure.

In another example embodiment, content may also refer to DICOM images, which may be contained in EMRs and/or EHRs. DICOM is a standard for transmitting, storing, printing and handling information in the medical imaging field. Medical imaging, as will be known in the art, may refer to any process and/or technique used to generate images of the human body, or parts or functions thereof, for medical and/or clinical purposes such as, for example, to diagnose, reveal or examine a disease. The standards set by DICOM facilitate interoperability of various medical imaging equipment across a domain of health enterprises by specifying and/or defining data structures, workflow, data dictionary, compression and workflow, among other things, for use in generating, transmitting and accessing the images and related information stored on the images. As used herein, a domain is all of the patient records (e.g., EMRs, EHRs, EPRs) stored within a patient ID assigning authority.

DICOM content refers to medical images following the file format definition and network transmission protocol as defined by the DICOM standards. DICOM content may include a range of biological imaging results and may include images generated through radiology and other radiological sciences, nuclear medicine, thermography, microscopy, microscopy and medical photography, among many others. DICOM content may be referred to hereinafter as images following the DICOM standard, and non-DICOM content for other forms and types of content, as will be known in the art.

Content may be generated and maintained within an institution such as, for example, an integrated delivery network, hospital, physician's office or clinic, to provide patients and health care providers, insurers or payers access to records of a patient across a number of facilities. Sharing of content may be performed using network-connected enterprise-wide information systems, and other similar information exchanges or networks, as will be known in the art.

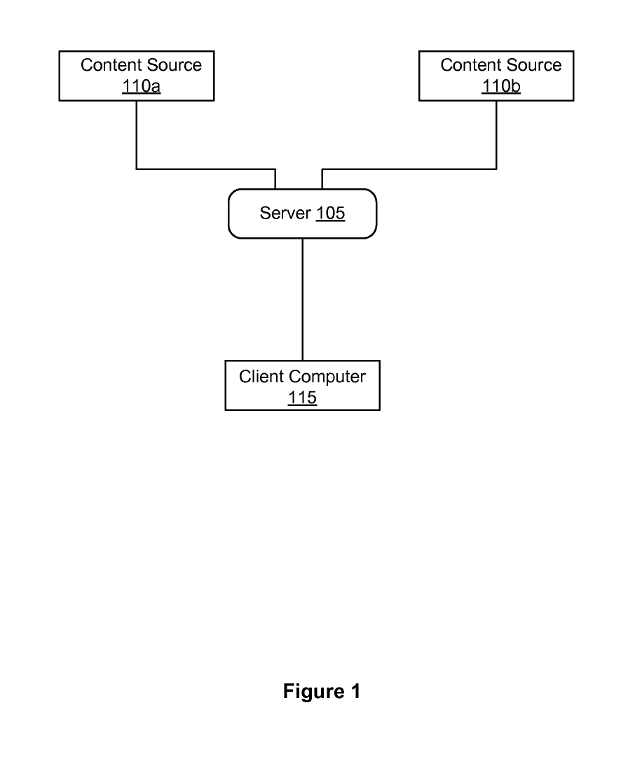

FIG. 1 shows an example system that includes a server 105, content sources 110a and 110b, and a client computer 115 for use in controlling user access to content generated from content sources 110a and 110b. Server 105 may be a VNA server that stores one or more content from content sources 110a and 110b. In one example embodiment, server 105 may be a database. In another example embodiment, server 105 may be used to connect client computer 115 to one or more databases used by content sources 110a and 110b to store content generated by content sources 110a and 110b.

While only two content sources 110a and 110b, and one client computer 115 are shown in the example system 100 for illustrative purposes, it will be understood that a plurality of servers, content sources and client computers may be connected to each other in a system. In one example embodiment, server 105 may contain records such as image records generated by content sources 110a and 110b. Client computer 115 may be connected to server 105 and is able to view content from the one or more content sources 110a and 110b.

Content sources 110a and 110b refer to producers of content that utilize a computing device to create and submit content having associated metadata for storage and registration in server 105. In one example embodiment, content sources 110a and 110b may each be a computing device used to generate the content.

In another example embodiment, content sources 110a and 110b may each be an imaging content source. Imaging content sources may be imaging devices that generate imaging assets (e.g., medical images) that may be made available to one or more users of system 100 that query and/or retrieve content from client computer 115. For example, imaging content sources may be medical imaging equipment such as MRI, X-Ray, ultrasound machines, mammography, CT scan or other similar equipment. In another example embodiment, content sources 110a and 110b may each be a computing device used by organizations that deliver care such as, for example, a physician's office or a hospital. Example computing devices may include, but are not limited to a mobile device or scanner that inserts medical images into the EMR.

Client computer 115 may be a computing device that allows a user to search and access content from server 105. Client computer 115 may be installed with an application that allows the user to log in and request access for content that the user may be authorized to view from server 105. For example, an authorized user may search and request access to EMRs for a particular day or patient.

Server 105, content sources 110a and 110b, and client computer 115 may be connected to each other in a network. The network may be any network, communications network, or network/communications network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, as discussed herein, and/or available or known at the time of filing, and/or as developed after the time of filing.

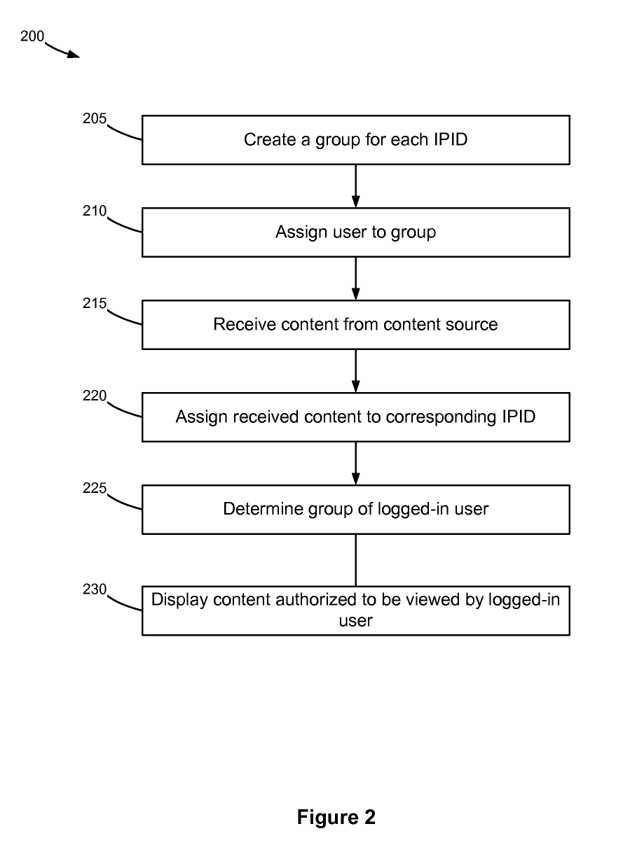

FIG. 2 shows one example method 200 for controlling user access to content generated by at least one of content sources 110a and 110b based on assigning authority and active groups. For illustrative purposes, example method 200 uses data corresponding to an assigning authority of user IDs, which in a DICOM environment is defined as the Issuer of Patient ID (IPID). The IPID is the assigning authority which assigns the patient IDs within the patient ID domain. The IPID may be a format that indicates the facility that assigns an ID to a user, and the ID is further associated to a content that is generated for the user. For example, if content source 110a, corresponding to Hospital A, generates an image record for a user, the image record generated by content source 110a will be tagged with the IPID of content source 110a to indicate that the image record was generated and is assigned to the Hospital A domain. Example method 200 ensures that the user is provided access to content that is generated by a facility to which the user is authorized to have access. Typically, the user will be provided access to content that is associated to the user (via a user identifier), but example method 200 provides an added level of access control by assigning the user to groups associated with the assigning authority that generates content the user is allowed to access.

At block 205, an administrator creates a group for each IPID. Creating a group for each IPID allows the administrator to assign users to a group based on the IPID, allowing the user for each group to view content of the group. For example, the administrator may create a first group, group_HospitalA group for Hospital A; and group_HospitalB, for Hospital B. In an alternative example embodiment, groups may be labeled with a prefix to indicate that the group is associated with an IPID. For example, groups may be labeled Acg_HospitalA to represent the Acuo Control Group of Hospital A. An application may check all the groups, and if the application detects the prefix, it may then check the suffix to determine the IPID.

In one example embodiment, the group created by the administrator may be a Windows domain group or any kind of computer network to which one or more users and devices such as computers, printers, and others, are registered. The users and devices that belong in the Windows group may be registered to a central database, which may be known in the art as a “directory service”. Each user of client computer 115 that is part of a group receives a unique user account and may be given access to resources and content within the domain.

The administrator then assigns one or more users of the system to the group having an IPID (at block 210). Assigning a user to a group indicates that the user is given access to content of that group. For example, a User 1 may be added to Hospital A and Hospital B groups, and another User 2 may be added only to Hospital A group. This indicates that User 1 is given access to records generated by Hospitals A and B, while User 2 is only given access to records generated by Hospital A.

For illustrative purposes, content source 110a may correspond to a content-generating device from Hospital A, and content source 110b may correspond to another content-generating device from Hospital B. At block 215, content from content source 110a and/or content source 110b may be received. Content from content sources 110a and 110b are typically configured for the respective issuer or content source (e.g., hospital). The received content records are then assigned or tagged with the corresponding IPID (at block 220). In one example embodiment, IPIDs are assigned to inbound content or incoming content generated from a facility, and the content may then be organized and stored by server 105. For example, images generated by content source 110a and received by server 105 are assigned with the HospitalA IPID, while images generated and received by server 105 from content source 110b are assigned with the HospitalB IPID.

For DICOM content, there are application entities (AEs) which may include an IP address, a port, and an AE title. The IPID may be associated with the AE title through configuration.

When a user logs on to an application in client computer 115 to view content, the application determines the user group assigned to the user based on the IPID (at block 225) and displays content authorized to be displayed for the logged-in user (at block 230). For example, when User 1 logs into the application, the application determines that User 1 is allowed access to Hospital A and Hospital B records. The application in client computer 115 then retrieves content associated with Hospital A and Hospital B IPIDs and provides User 1 access to those records. Similarly, for User 2 who is only given access to records from Hospital A, the application gives User 2 access only to content associated with Hospital A.

It will be understood that the example applications described herein are illustrative and should not be considered limiting. It will be appreciated that the actions described and shown in the example flowcharts may be carried out or performed in any suitable order. It will also be appreciated that not all of the actions described in FIG. 2 need to be performed in accordance with the example embodiments of the disclosure and/or additional actions may be performed in accordance with other example embodiments of the disclosure.

Many modifications and other example embodiments of the disclosure set forth to herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for controlling user access to content in a multi-enterprise environment, comprising:
associating a first group to a first facility in the multi-enterprise environment;
associating a second group to a second facility in the multi-enterprise environment;
assigning a user to at least one of the first and second groups; and
displaying on a user interface content generated by the first facility to the user if the user is assigned to the first group.

2. The method of claim 1, further comprising displaying on the user interface content generated by the second facility if the user is assigned to the second group.

3. The method of claim 1, wherein the associating the first group to the first facility comprises associating an identifier from a first assigning authority to the first group.

4. The method of claim 3, wherein the content generated by the first facility is associated with the identifier.

5. The method of claim 1, wherein the associating the first group to the first facility comprises associating an Issuer of Patient ID (IPID) of the first facility to the first group.

6. The method of claim 5, wherein the content generated by the first facility is associated with the IPID.

7. The method of claim 1, wherein the associating the first group and the second group with the first facility and the second facility, respectively, includes adding a content identifier to a property of the first and the second groups.

8. The method of claim 1, wherein the first facility and the second facility are assigning authorities of one or more IDs associated with the one or more users.

9. A system for controlling user access to content, comprising:
one or more content sources that generate content associated with a user; and
a server having one or more computer instructions for:
receiving the content from the one or more content sources;
associating the content with the content source that generated the content;
creating a group for each of the one or more content sources; and
assigning a user to one or more groups, thereby allowing the user to access content generated by the content source corresponding to the group assigned to the user.

10. The system of claim 8, further comprising a client computer having an application that sends a request to the server for content to which the user is allowed access.

11. The system of claim 9, wherein the server includes a computer instruction that determines the one or more groups to which the user is assigned.

12. The system of claim 10, wherein the server further includes a computer instruction that sends the content associated with the one or more groups of the user to the client computer.

13. The system of claim 10, wherein the associating of the content with the content source that generated the content includes adding a content source identifier to a property of the content.

14. The system of claim 8, wherein the content sources are assigning authorities of one or more IDs associated with the user.

15. The system of claim 8, wherein the content source generates content that is associated with the user.

16. A computing device having one or more instructions stored in a non-transitory computer readable storage medium to:
receive content generated from one or more content sources;
associate the content with the content source that generated the content;
create one or more groups associated with the one or more content sources;
assign a user to at least one of the created groups; and
provide the user access to content generated by at least one of the one or more content sources based on the one or more groups assigned to the user.

17. The computing device of claim 15, wherein the instruction to associate the content with the content source that generated the content includes tagging the content with a content source identifier.

18. The computing device of claim 16, wherein the instruction to associate the content with the content source includes modifying a property of the content to add a content source identifier corresponding to the content source that generated the content.

19. The computing device of claim 15, wherein the instruction to create one or more groups associated with the one or more content sources includes creating a database of one or more users that are allowed access to content generated by content source associated with the database.

20. The computing device of claim 15, wherein the instruction to receive the content generated from the one or more content sources includes receiving content generated by one or more assigning authorities.

21. A method for controlling user access to content in a multi-enterprise environment, comprising:
receiving the content from at least two patient ID assigning authority domains;
associating the content with the patient ID assigning authority domain that generated the content;
creating a group for each of the patient ID assigning authority domains;
assigning a user to at least one of the groups; and
allowing the user to access the content corresponding to the user's assigned group(s).
